(19) United States
(12) Patent Application Publication
(10) Pub. No.: US 2014/0125447 A1
(43) Pub. Date: May 8, 2014

(54) Resistance calibrating circuit

(71) Applicant: IPGoal Microelectronics (Sichuan) Co., Ltd., Chengdu (CN)

(72) Inventor: Fangping Fan, Chengdu (CN)

(73) Assignee: IPGoal Microelectronics (Sichuan) Co., Ltd., Chengdu (CN)

(21) Appl. No.: 14/065,993

(22) Filed: Oct. 29, 2013

(30) Foreign Application Priority Data
Nov. 6, 2012 (CN) 201210438700.X

(51) Int. Cl. H01C 7/10

(52) U.S. Cl. CPC H01C 7/10
USPC 338/20

(57) ABSTRACT

A resistance calibrating circuit includes an external power source; a reference unit, a current calibrating circuit and a voltage calibrating unit which are respectively connected to the external power source; an external reference voltage which is respectively connected to the reference unit and the voltage calibrating unit; an to-be-calibrated voltage-controlled resistor which is respectively connected to the current calibrating unit and the voltage calibrating unit, wherein the current calibrating unit is further connected to the reference unit. The resistance calibrating circuit is capable of automatically adjusting a resistance of the to-be-calibrated voltage-controlled resistor highly precisely and highly efficiently.

### FIELD OF INVENTION

The present invention relates to an integrated circuit, and more particularly to a resistance calibrating circuit for automatically calibrating a resistance of an in-chip resistor.

### DESCRIPTION OF RELATED ARTS

In the manufacture processes of various chips, the resistance of the in-chip resistor is closely related to the manufacture arts, so it is usually difficult to directly produce an in-chip resistor having a precise resistance, which requires additionally calibrating the resistance of the in-chip resistor.

According to the prior arts, the resistance of the in-chip resistors is usually calibrated via manually adjusting, i.e., via measuring the resistance of the in-chip resistor and correspondently controlling and adjusting the resistance, so as to obtain a relatively precise resistance. However, the manner of manually adjusting has a low efficiency and a low adjustment precision; it is difficult to adjust the resistances of resistors of all the chips into the expected values having relatively high precision via the manner.

Thus it is necessary to provide a resistance calibrating circuit to overcome the above disadvantages.

### SUMMARY OF THE PRESENT INVENTION

An object of the present invention is to provide a resistance calibrating circuit which is capable of automatically adjusting a resistance of a to-be-calibrated voltage-controlled resistor highly precisely and highly efficiently.

Accordingly, in order to accomplish the above objects, the present invention provides a resistance calibrating circuit comprising an external power source; a reference unit, a current calibrating unit and a voltage calibrating unit, which are respectively connected to the external power source; an external reference voltage which is respectively connected to the reference unit and the voltage calibrating unit; and a to-be-calibrated voltage-controlled resistor which is respectively connected to the current calibrating unit and the voltage calibrating unit, wherein the current calibrating unit is further connected to the reference unit.

Preferably, the reference unit comprises a reference resistor and and is respectively connected to the external reference voltage and the external power source, in such a manner that the reference resistor obtains defined current and voltage values; the voltage calibrating unit is respectively connected to the external reference voltage, the external power source and the to-be-calibrated voltage-controlled resistor, in such a manner that the to-be-calibrated voltage-controlled resistor obtains an identical voltage value to the reference resistor; and the current calibrating unit is respectively connected to the reference unit, the external power source and the to-be-calibrated voltage-controlled resistor, in such a manner that the to-be-calibrated voltage-controlled resistor obtains a proportional current value to the reference resistor.

Preferably, the reference unit further comprises a first operational amplifier (OA) whose non-inverting input terminal is connected to the external reference voltage and whose inverting input terminal and output terminal are both connected to a first terminal of the reference resistor; a second terminal of the reference resistor is connected to ground.

Preferably, the reference unit further comprises a first field effect transistor (FET), wherein an inverting input terminal of the first OA is connected to a source electrode of the first FET; an output terminal of the first OA is connected to a gate electrode of the first FET; a drain electrode of the first FET is connected to the external power source; and the source electrode of the first FET is connected to a first terminal of the reference resistor.

Preferably, the current calibrating unit comprises a second FET and a third FET, wherein a source electrode of the second FET and a source electrode of the third FET are both connected to the external power source; a gate electrode and a drain electrode of the second FET, a gate electrode of the third FET and a drain electrode of the first FET are connected together; a drain electrode of the third FET is connected to a first terminal of the to-be-calibrated voltage-controlled resistor; a second terminal of the to-be-calibrated voltage-controlled resistor is connected to ground; and the second FET proportionally mirrors the current value of the reference resistor into the third FET.

Preferably, the voltage calibrating unit comprises a second OA whose non-inverting input terminal is connected to the external reference voltage, whose inverting input terminal is connected to the first terminal of the to-be-calibrated voltage-controlled resistor and whose output terminal is connected to a control terminal of the to-be-calibrated voltage-controlled resistor.

Preferably, the first OA and the second OA are identical, i.e., have identical parameters and features.

Compared to prior arts, in the resistance calibrating circuit of the present invention, the current calibrating unit and the voltage calibrating unit are respectively connected to the to-be-calibrated voltage-controlled resistor, so the current calibrating unit and the voltage calibrating unit adjust the current and the voltage of the to-be-calibrated voltage-controlled resistor with reference to the reference unit, in such a manner that a resistance of the to-be-calibrated resistor which is connected into an integral circuit is of a required value, so as to accomplish a precise adjustment of the resistance of the to-be-calibrated voltage-controlled resistor without manually adjusting, improve an adjustment efficiency and maintain an adjustment precision.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a resistance calibrating circuit according to a preferred embodiment of the present invention.

FIG. 2 is a first circuit diagram of the resistance calibrating circuit according to the preferred embodiment of the present invention.

FIG. 3 is a second circuit diagram of the resistance calibrating circuit according to the preferred embodiment of the present invention.

### DETAILED DESCRIPTION OF THE PREFERRED EMBODIMENT

The present invention provides a resistance calibrating circuit capable of automatically adjusting a resistance of a to-be-calibrated voltage-controlled resistor highly precisely and highly efficiently.

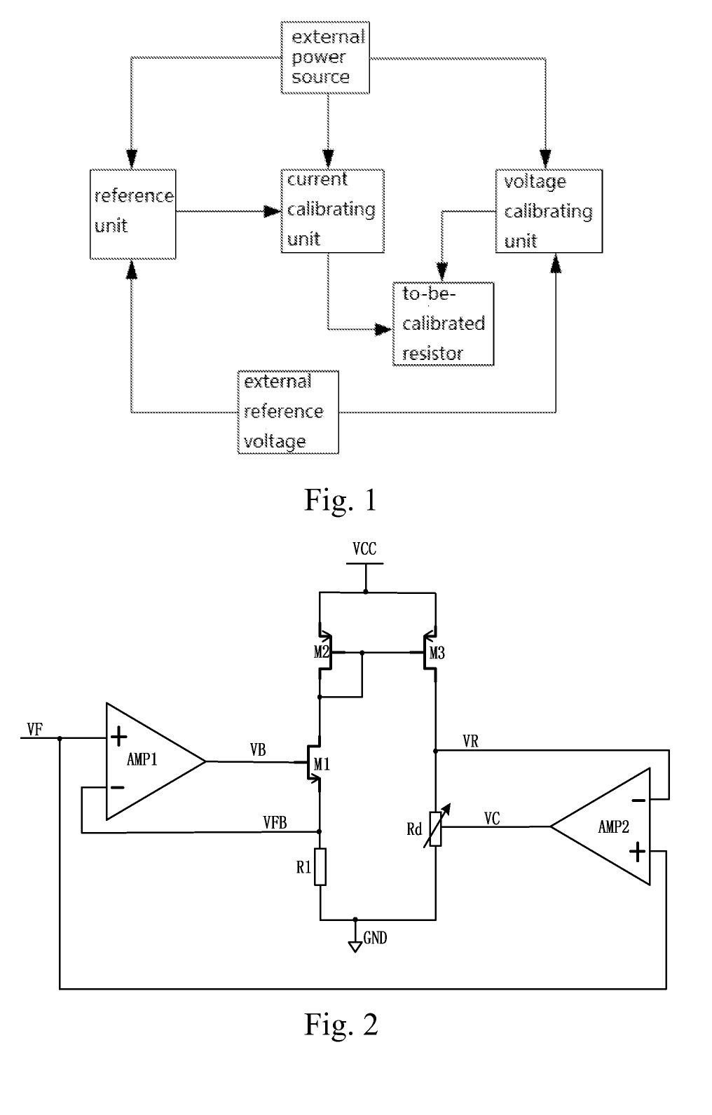

FIG. 1 shows a block diagram of the resistance calibrating circuit according to a preferred embodiment of the present invention. Referring to FIG. 1, the resistance calibrating circuit comprises an external power source; a reference unit, a current calibrating unit and a voltage calibrating unit, which are respectively connected to the external power source; an external reference voltage which is respectively connected to the reference unit and the voltage reference unit; and a to-be-calibrated voltage-controlled resistor which is respectively connected to the current calibrating unit and the voltage calibrating unit, wherein the current calibrating unit is further connected to the reference unit. The reference unit comprises a reference resistor; the reference unit is respectively connected to the external reference voltage and the external power source, in such a manner that the reference resistor obtains defined current and voltage values; the voltage calibrating unit is respectively connected to the external reference voltage, the external power source and the to-be-calibrated voltage-controlled resistor, in such a manner that the to-be-calibrated resistor has an identical voltage value to the reference resistor; the current calibrating unit is respectively connected to the reference unit, the external power source and the to-be-calibrated voltage-controlled resistor, in such a manner that the to-be-calibrated voltage-controlled resistor has a proportional current value to the reference resistor. The current calibrating unit and the voltage calibrating unit cooperate with each other and supply the to-be-calibrated voltage-controlled resistor with fixed current and voltage values with reference to the current and voltage values of the reference resistor, so as to accomplish precisely adjusting the resistance of the to-be-calibrated voltage-controlled resistor according to a proportion of the resistance of the reference resistor.

Further referring to FIG. 2, according to the preferred embodiment of the present invention, the reference unit comprises a first OA AMP1, a first FET M1 and a reference resistor R1; the voltage calibrating unit comprises a second AMP2; the current calibrating unit comprises a second FET M2 and a third FET M2. Specifically, the external reference voltage VF is respectively connected to a non-inverting input terminal of the first OA AMP1 and a non-inverting input terminal of the second OA AMP2; an inverting input terminal of the first OA AMP1 is connected to a source electrode of the first FET M1; an output terminal of the first OA AMP1 is connected to a gate electrode of the first FET M1; and an output voltage of the output terminal of the first OA AMP1 is defined as VB. A first terminal of the reference resistor R1 is connected to a source electrode of the first FET M1; a second terminal of the reference resistor R1 is connected to ground; and voltage values of two terminals of the reference resistor R1 are defined as VFB. A drain electrode of the first FET M1 is respectively connected to a drain electrode and a gate electrode of the second FET M2, in such a manner that the first OA AMP1 and the first FET M1 together form a first feedback loop. A source electrode of the second FET M2 and a source electrode of the third FET M3 are both connected to the external power source VCC; a gate electrode of the second FET M2 is connected to a gate electrode of the third FET M3. A drain electrode of the third FET M3 is connected to a first terminal of the to-be-calibrated voltage-controlled resistor Rd; a second terminal of the to-be-calibrated voltage-controlled resistor Rd is connected to ground. An inverting input terminal of the second OA AMP2 is connected to the drain electrode of the third FET M3; an input voltage of the inverting input terminal of the second OA AMP2 is defined as VR; an output terminal of the second OA AMP2 is connected to a control terminal of the to-be-calibrated voltage-controlled resistor Rd; an output voltage of the output terminal of the second OA AMP2 is defined as Vc; in other words, the voltage Vc is a control voltage of the to-be-calibrated voltage-controlled resistor Rd, in such a manner that the second OA AMP2 and the to-be-calibrated resistor Rd together form a second feedback loop.

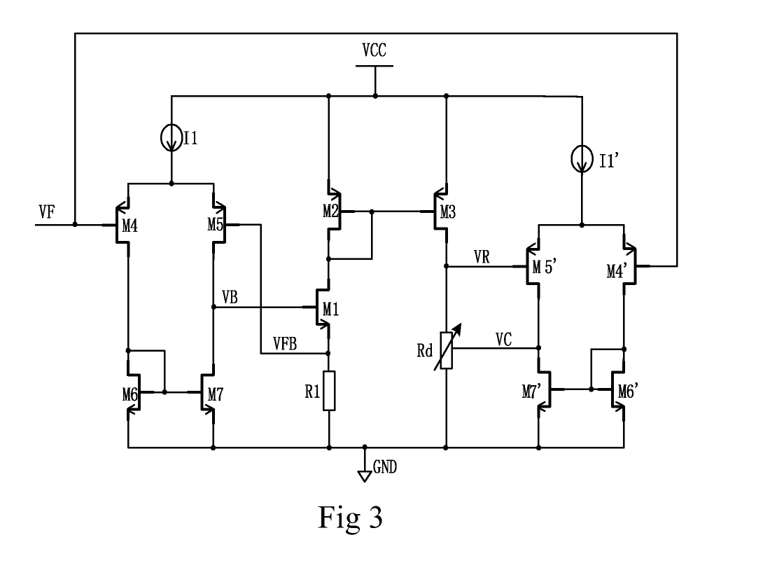

Further referring to FIG. 3, preferably, the first OA AMP1 and the second OA AMP2 have identical parameters and features. The first OA AMP1 comprises a first current source I1, a fourth FET M4, a fifth FET M5, a sixth FET M6 and a seventh FET M7. A gate electrode of the fourth FET M4 is connected to the external reference voltage VF. A source electrode of the fourth FET M4, a source electrode of the fifth FET M5 and a first terminal of the first current source I1 are connected together. A drain electrode of the fourth FET M4, a drain electrode and a gate electrode of the sixth FET M6 and a gate electrode of the seventh FET M7 are connected together. A drain electrode of the fifth FET M5, a drain electrode of the seventh FET M7 and the gate electrode of the first FET M1 are connected together; a voltage of the drain electrode of the seventh FET M7 is defined as VB. A gate electrode of the fifth FET M5 is connected to the source electrode of the first FET M1; a voltage of the gate electrode of the fifth FET M5 is defined as VFB. A second terminal of the first current source I1 is connected to the external power source VC and the first current source I1 supplies the fourth FET M4 and the fifth FET M5 with biasing currents. The second operational amplifier AMP2 comprises a second current source IF, an eighth FET M4′, a ninth FET M5′, a tenth FET M6′ and an eleventh FET M7′; a voltage of a gate electrode of the ninth FET M5′ is defined as VR and a voltage of a drain electrode of the tenth FET M7′ is defined as VC. As mentioned above, the second OA AMP2 and the first OA AMP1 have identical parameters and features. Each element of the second OA AMP2 is connected identically to the each element of the first OA AMP1 without repeating again, as showed in FIG. 3.

Referring to FIGS. 1˜3, the resistance calibrating circuit of the present invention has following working principles. A voltage value of the external reference voltage VF is set to be VREF, i.e., the input voltage of the non-inverting input terminal of the first OA AMP1 is VREF; a width to length ratio of the fourth FET M4 is set to be identical to that of the fifth FET M5; a width to length ratio of the sixth FET M6 is identical to that of the seventh FET M7; and a ratio of a width to length ratio of the second FET M2 to that of the third FET M3 is set to be n which is a positive integer. As showed in FIG. 2 and FIG. 3, the second FET M2 is capable of proportionally mirroring the current thereof into the third FET M3, which means that a mirror ratio of a current of the second FET M2 to a current of the third FET M3 is n. Accordingly, a width to length ratio of the eighth FET M4′ is set to be identical to that of the ninth FET M5′; a width to length ratio of the tenth FET M6′ is set to be identical to that of the eleventh FET M7′. A resistor having a resistance which satisfies design requirements is chosen to be the reference resistor R1 and the resistance of the reference resistor R1 is defined as Rref; the resistance of the to-be-calibrated voltage-controlled resistor Rd is defined as Rctr1. Because of inherent features of the voltage-controlled resistors, the resistance of the to-be-calibrated voltage-controlled resistor Rd changes with the control voltage Vc, which means that the control voltage Vc controls the resistance of the to-be-calibrated resistor Rd, wherein specific control relationships between the resistance Rctr1 and the control voltage Vc are understood by one skilled in the art and thus not repeated again herein. The relationship between the resistance Rctr1 and the control voltage Vc is expressed as: Rctr1=f(Vc).

The fourth FET M4, the fifth FET M5, the sixth FET M6, the seventh FET M7, the first FET M1 and the first current source I1 together form the first feedback loop; according to inherent features of the feedback loop, the value of the gate electrode voltage VFB of the fifth FET M5 is identical to the value of the reference voltage VF, i.e., VREF=VFB, in such a manner that a current running through the reference resistor R1 is

$$\frac{VREF}{Rref} or \frac{VFB}{Rref} ;$$

the ratio of the width to length ratio of the second FET M2 to that of the third FET M3 is n, so the current running through the to-be-calibrated voltage-controlled resistor Rd is n times of the current running through the reference resistor R1, i.e.,

$$\frac{nVREF}{Rref} .$$

As a result, the voltage value VR of the first terminal of the to-be-calibrated voltage-controlled resistor Rd is:

$$VR = \frac{nVREF}{Rref} * Rctrl = \frac{nVREF}{Rref} * f ( Vc ) \qquad ( 1 )$$

The eight FET M4′, the ninth FET M5′, the tenth FET M6′, the eleventh FET M7′, the second current source I1′ and the second resistor Rd together form the second feedback loop and the second OA AMP2 have identical parameters and features to the first OA AMP1, so the value of the gate electrode voltage VR of the eight FET M8 is identical to the value VREF of the external reference voltage VF, namely VREF=VR. Thus the equation (1) is transformed as:

$$\frac{Rref}{n} = Rctrl = f ( Vc ) ,$$

which means that the resistance of the to-be-calibrated voltage-controlled resistor Rd is adjusted via the voltage at two ends thereof and the current running therethrough to finally become proportional to the resistance of the reference resistor R1; since the resistance of the reference resistor R1 is predefined and thus already known, the resistance of the to-be-calibrated voltage-controlled resistor Rd is precisely adjusted via the voltage calibrating unit and the current calibrating unit with reference to the resistance of the reference resistor.

As a conclusion, the resistance calibrating circuit of the present invention accomplishes automatically adjusting the resistance of the to-be-calibrated voltage-controlled resistor Rd, with reference to the standard reference resistor R1, to obtain the resistance of the to-be-calibrated voltage-controlled resistor in proportional to the resistance of the standard reference resistor R1, wherein the adjusting is highly precisely and highly efficiently without manual adjustment.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A resistance calibrating circuit, comprising an external power source; a reference unit, a current calibrating unit and a voltage calibrating unit which are respectively connected to said external power source; an external reference voltage which is respectively connected to said reference unit and said voltage calibrating unit; and a to-be-calibrated voltage-controlled resistor which is respectively connected to said current calibrating unit and said voltage calibrating unit, wherein said current calibrating unit is further connected to said reference unit.

2. The resistance calibrating circuit, as recited in claim 1, wherein said reference unit comprises a reference resistor; said reference unit is respectively connected to said external reference voltage and said external power source, in such a manner that said reference resistor has a defined current value and a defined voltage value; said voltage calibrating unit is respectively connected to said external reference voltage, said external power source and said to-be-calibrated voltage-controlled resistor, in such a manner that said to-be-calibrated voltage-controlled resistor has an identical voltage value to said reference resistor; said current calibrating unit is respectively connected to said reference unit, said external power source and said to-be-calibrated voltage-controlled resistor, in such a manner that said to-be-calibrated voltage-controlled resistor has a proportional current value to said reference resistor.

3. The resistance calibrating circuit, as recited in claim 2, wherein said reference unit further comprises a first OA; a non-inverting input terminal of said first OA is connected to said external reference voltage; an inverting input terminal and an output terminal of said first OA are both connected to a first terminal of said reference resistor; and a second terminal of said reference resistor is connected to ground.

4. The resistance calibrating circuit, as recited in claim 3, wherein said reference unit further comprises a first FET; a source electrode of said first FET is connected to said inverting input terminal of said first OA; a gate electrode of said first FET is connected to said output terminal of said first OA; a drain electrode of said first FET is connected to said external power source; and said source electrode of said first FET is connected to said first terminal of said reference resistor.

5. The resistance calibrating circuit, as recited in claim 4, wherein said current calibrating unit comprises a second FET and a third FET; a source electrode of said second FET and a source electrode of said third FET are both connected to said external power source; a gate electrode and a drain electrode of said second FET, a gate electrode of said third FET and said drain electrode of said first FET are connected together; a drain electrode of said third FET is connected to a first terminal of said to-be-calibrated voltage-controlled resistor; a second terminal of said to-be-calibrated voltage-controlled resistor is connected to ground; and said second FET proportionally mirrors a current value of said reference resistor into said third FET.

6. The resistance calibrating circuit, as recited in claim 5, wherein said voltage calibrating unit comprises a second OA; a non-inverting input terminal of said second OA is connected to said external reference voltage; an inverting input terminal of said second OA is connected to said first terminal of said to-be-calibrated voltage-controlled resistor; and an output terminal of said second OA is connected to a control terminal of said to-be-calibrated voltage-controlled resistor.

7. The resistance calibrating circuit, as recited in claim 6, wherein said first OA and said second OA have identical parameters.
